(19) United States
(12) Patent Application Publication
(10) Pub. No.: US 2020/0123855 A1
(43) Pub. Date: Apr. 23, 2020

(54) TELESCOPING STEP LADDER SAFETY HAND RAILS AND BEAM

(71) Applicant: John Gian, Calgary (CA)

(72) Inventor: John Gian, Calgary (CA)

(21) Appl. No.: 16/560,070

(22) Filed: Sep. 4, 2019

(30) Foreign Application Priority Data
Oct. 22, 2018 (CA) 3021756

(51) Int. Cl. E06C 7/18; E06C 7/14

(52) U.S. Cl. CPC E06C 7/183; E06C 7/14

(57) ABSTRACT

A telescoping safety hand rail and beam for step ladders. The invention consists of two upright telescopic rails and a telescopic horizontal beam and tray. The tray includes a container, various pass-through openings for holding tools, a paint can hook and a pass through orifice to accept the horizontal beams to allow telescopic movement. The inner rails extend upwards from the fixed outer rails and latch in place at the top and middle of the telescoping travel range. This advantageously allows the utilization of all steps of a ladder by providing a supplemental knee brace and eliminates the dangerous opportunity to stand unbraced on any step of a ladder. The invention is mounted to a step ladder with strategically placed lap hooks and double sided mounting tape.

### BACKGROUND OF THE INVENTION

### 1. Field of the Invention

This invention relates to ladder safety devices, more particularly to telescoping hand rails and beam with a tray for holding tools and the like for use on step ladders, providing supplemental user balance support and access to tools.

### 2. Description of Related Art

An attempt at providing height adjustability of a utility shelf for step ladders is disclosed in U.S. Pat. No. 5,740,883 issued to Trank. The device disclosed is a height adjustable ladder tool accessory box for holding tools, hardware, supplies, paint containers, and the like. The tool accessory box is attached to a ladder using wedged shaped mounting brackets, these place the elongated support members parallel to each other. Trank's tool accessory box is designed with a thin slotted shelf tool holder on the front, where if one were to brace against, would not be practical. Trank's mounting instructions includes passing fasteners through plurality of apertures on the mounting brackets. This will void any ladders warranty and structural integrity, deeming it unusable.

An attempt at providing height adjustability of a utility shelf for step ladders is disclosed in U.S. Pat. No. 5,544,718 issued to Schumacher. The device is attached to a step ladder by two retraction tubes which are each mounted on the steps of the ladder. The device attaches to the steps of a step ladder thereby reducing the available area for the user to stand. The extending tubes may interfere with the individual's footing while on the ladder, and therefore introduces additional risk for anyone using a ladder equipped with the device. The horizontal release bar for the spring loaded clamps appear to be located at the top rung, this would make using the top rung and plate inaccessible. Schumacher's tray consists of one compartment. Schumacher's mounting instructions included using screws, this will void any ladders warranty and structural integrity, deeming it unusable.

### OBJECT AND ADVANTAGES

In terms of providing supplemental knee support when using the upper portions of the step ladder, there are no prior arts. In terms of providing side rails for climbing to and from the upper levels, there are no prior arts. This invention is revolutionary due to the fact that currently there are only warning labels stating you may lose your balance if you decide to use the top rung or above. I found that use of these forewarned steps is more common than not. It is consistently one of Occupational Health and Safety's top citation. 97.3% of the 500,000 yearly US ladder accidents needing medical treatment happen at a non-occupational setting. Of these, 164,000 was sent to the emergency room and approximately 300 incidents prove to be fatal. The proposed invention converts any step ladder into a semi-platform ladder, providing a supplemental knee brace when standing on the top step and a hand rail for climbing to and from the upper portions of the step ladder. Step ladders are due for something more than just warning labels.

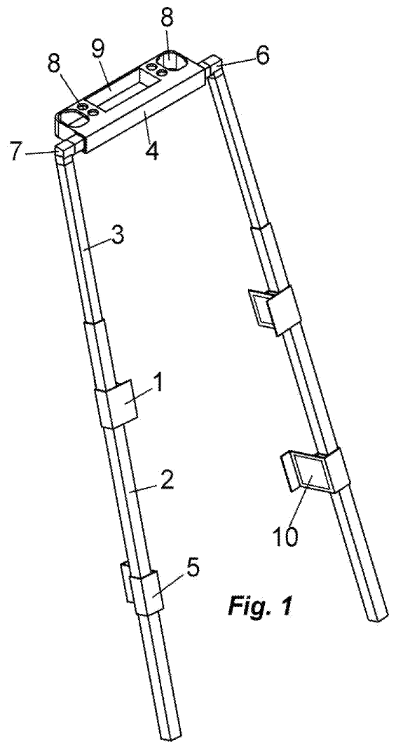

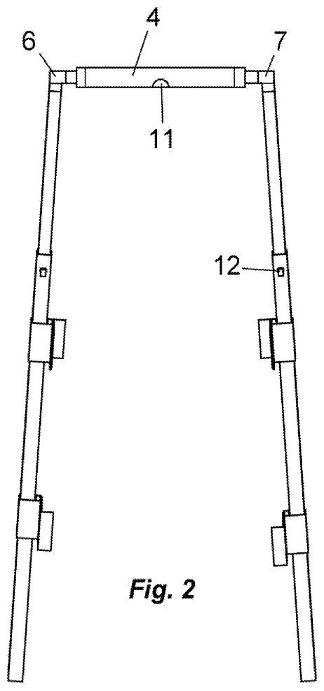

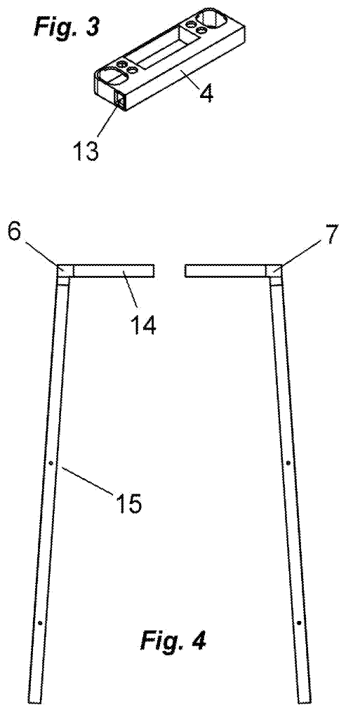

In the drawings which illustrate embodiments of the invention, FIG. 1 is an isometric view of this embodiment shown at its middle indexing position. FIG. 2 is a back view of this embodiment shown at its middle indexing position. FIG. 3 is an isometric view of the tray (4). FIG. 4 is a back view of the inner rails with the outer rails (2) and tray (4) removed.

### DESCRIPTION OF PREFERRED EMBODIMENT

Step ladders essentially comprises of front side rails, rear support legs, horizontal locking spreader bars, rungs and a top cap. The invention comprises of two upright telescopic rails (2, 3) and a horizontal telescopic beam/tray (4, 14). The upright inner rails (3) extend upwards from the fixed outer rails (2) and latch in place using the indexing pins (12) at essentially the top and middle of the telescoping travel range when indexed to the indexing holes (15). The top indexing position places the tray (4) at the same height as if you were standing on the second to top rung and bracing your knees into the top plate of a ladder. The middle indexing position is essentially 12 inches lower than the top indexing position, giving you a knee brace for standing on the top rung. This advantageously allows you to use 100% of the ladder and eliminates any chance of standing unbraced on any level. With this invention, it makes the upper portion of step ladders safer to use.

The telescoping beam/tray (4, 14) is essential because the two fixed outer rails (2) are connected to the ladders non-parallel “A” shaped front rails. The tray (4) includes a common orifice (13) to receive the two essentially horizontal inner rails (14), tray (4) essentially allows the left and right essentially horizontal inner rails (14) to telescope within its orifice (13), tray (4) includes various pass through openings (8) for holding tools and the like, includes a protruding member (11) to accept a wire handle, includes a container body (9) having a plurality of side walls and bottom joined together.

In this embodiment mentioned, the use of manufactured elbows (6, 7) was desired. These elbows (6, 7) are mirrored copies of each other. They follow the common slopes of standard A-framed step ladders. Their function is to connect the upright inner rails (3) to the horizontal inner rails (14). Another embodiment would be to weld the horizontal rails (14) to the upright inner rails (3).

The upper and lower brackets (1, 5) are attached to the ladder using high strength double sided adhesive tape. The upper brackets (1) have a perpendicular front lap hook and the lower brackets (5) have a perpendicular back lap hook. These hooks combined with the adhesive tape (10) and cantilever action, secures the invention to the ladder without the use of fasteners which would have effect a ladders structural integrity and void its warranty. The upper brackets (1) are fixed to the lower rail (2). In cases where a ladder uses horizontal locking spreader bars on the outer surface where the brackets are installed on, the lower brackets (5) are free to move along the fixed outer rail (2) to allow locating placement that does not interfere with the ladders horizontal locking spreader bars. If the ladder uses inside horizontal locking spreader bars, the lower bracket should be mounted flush to the bottom of the fixed outer rail (2). This makes the invention universal for virtually all step ladders. The upper and lower brackets (1, 5) essentially raise the outer tube from the mounting surface to allow for a ladders horizontal locking spreader bars to clear under the fixed outer rails (2).

While a preferred embodiment of the invention has been described using specific terms, such description is for illustrative purposes only, and it is to be understood that changes and variations may be made without departing from the intent or scope of the following claims.

The embodiments of the invention in which an exclusive property or privilege is claimed are defined as follows:

1. A safety device and tool tray used on a step ladder comprising front side rails and horizontal locking spreaders bars, the safety device comprising:
a. a pair of essentially upright elongated outer tubes, each with a single fixed upper mounting bracket and a single unfixed lower mounting bracket, said essentially upright elongated outer tubes are mounted on the front side rails, said upper brackets have an essentially perpendicular front lap hook that hooks over a front edge of the front side rails, these said upper brackets are fixed to the essentially upright elongated outer tubes, said lower brackets have an essentially perpendicular back lap hook that hooks over a back edge of the front side rails, these said lower brackets are mounted after finding a location along the length of said outer tubes that is below the said upper bracket and does not interfere with the horizontal locking spreader bars of the step ladder, said upper and lower brackets raise the said essentially upright elongated outer tubes from the step ladder front side rails to allow for the horizontal locking spreader bars of the step ladder to clear under the said essentially upright elongated outer tubes, said upper and lower brackets are secured to the step ladder using high strength double sided mounting tape;
b. a pair of essentially upright elongated inner tubes, said elongated tubes have a smaller outside dimension then the inside dimension of the elongated outer tubes, when inserted into the elongated outer tubes they produce a telescoping tube;
c. a pair of essentially horizontal inner tubes, each one of the pair of essentially horizontal inner tubes is connected to one of the pair of essentially upright elongated inner tubes using one of a pair of plastic molded elbows to form a essentially right angle assembly, wherein one end of one of the pair of plastic molded elbows is inserted into one of the pair of essentially upright elongated inner tubes and the other end of the one of the pair of plastic molded elbows is inserted into one of the pair of essentially horizontal inner tubes;
d. a tool tray, that includes a tunnel to receive the two essentially horizontal inner tubes, said tool tray essentially allows the essentially horizontal inner tubes to telescope within the said tunnel, said tunnel may be open ended or be divided with a wall within, said tool tray includes various pass through openings for holding tools and the like, said tool tray includes a protruding member to accept a wire handle, said tool tray includes a container body having a plurality of side walls and bottom joined together;
e. each upright elongated telescoping tube includes an indexing pin to stop the essentially upright elongated inner tube in position;
f. both upright elongated telescoping tubes include a matching plurality of indexing hole positions for the said indexing pins to stop in;

2. A step ladder safety device and tool tray as in claim 1 wherein said telescopic tubes may be any shape of tubing including square, round, rectangular, oval, triangular or oblique.

3. A step ladder safety device and tool tray as in claim 1 is secured to the step ladder with structurally approved fasteners, adhesives and clamps.

4. A step ladder safety device and tool tray as in claim 1 may be made from any combination of metals, composites or plastics.

5. A step ladder safety device and tool tray as in claim 1 wherein said telescopic tubes are stopped using telescoping tube clamps.

6. A safety device used on a step ladder comprising front side rails and horizontal locking spreaders bars, the safety device comprising:
a. a pair of essentially upright elongated outer tubes, each with a single fixed upper mounting bracket and a single unfixed lower mounting bracket, said essentially upright elongated outer tubes are mounted on the front side rails, said upper brackets have an essentially perpendicular front lap hook that hooks over a front edge of the front side rails, these said upper brackets are fixed to the essentially upright elongated outer tubes, said lower brackets have an essentially perpendicular back lap hook that hooks over a back edge of the front side rails, these said lower brackets are mounted after finding a location along the length of said outer tubes that is below the said upper bracket and does not interfere with the horizontal locking spreader bars of the step ladder, said upper and lower brackets raise the said essentially upright elongated outer tubes from the step ladder front side rails to allow for the horizontal locking spreader bars of the step ladder to clear under the said essentially upright elongated outer tubes, said upper and lower brackets are secured to the step ladder using high strength double sided mounting tape;
b. a pair of essentially upright elongated inner tubes, said elongated tubes have a smaller outside dimension then the inside dimension of the elongated outer tubes, when inserted into the elongated outer tubes they produce a telescoping tube;
c. a pair of essentially horizontal inner tubes, each one of the pair of essentially horizontal inner tubes is connected to one of the pair of essentially upright elongated inner tubes using one of a pair of plastic molded elbows to form a essentially right angle assembly, wherein one end of one of the pair of plastic molded elbows is inserted into one of the pair of essentially upright elongated inner tubes and the other end of the one of the pair of plastic molded elbows is inserted into one of the pair of essentially horizontal inner tubes;
d. an essentially horizontal outer tube to receive the essentially horizontal inner tubes;
e. each upright elongated telescoping tube includes an indexing pin to stop the essentially upright elongated inner tube in position;
f. both upright elongated telescoping tubes include a matching plurality of indexing hole positions for the said indexing pins to stop in;

7. A step ladder safety device as in claim 6 wherein said telescopic tubes may be any shape of tubing including square, round, rectangular, oval, triangular or oblique.

8. A step ladder safety device as in claim 6 is secured to the step ladder with structurally approved fasteners, adhesives and clamps.

9. A step ladder safety device as in claim 6 may be made from any combination of metals, composites or plastics.

10. A step ladder safety device as in claim 6 wherein said telescopic tubes are stopped using telescoping tube clamps.

11. A safety device and tool tray used on a step ladder comprising front side rails and horizontal locking spreaders bars, the safety device comprising:
a. a pair of essentially upright elongated outer tubes, each with a single fixed upper mounting bracket and a single unfixed lower mounting bracket, said essentially upright elongated outer tubes are mounted on the front side rails, said upper brackets have an essentially perpendicular front lap hook that hooks over a front edge of the front side rails, these said upper brackets are fixed to the essentially upright elongated outer tubes, said lower brackets have an essentially perpendicular back lap hook that hooks over a back edge of the front side rails, these said lower brackets are mounted after finding a location along the length of said outer tubes that is below the said upper bracket and does not interfere with the horizontal locking spreader bars of the step ladder, said upper and lower brackets raise the said essentially upright elongated outer tubes from the step ladder front side rails to allow for the horizontal locking spreader bars of the step ladder to clear under the said essentially upright elongated outer tubes, said upper and lower brackets are secured to the step ladder using high strength double sided mounting tape;
b. a pair of essentially upright elongated inner tubes, said elongated tubes have a smaller outside dimension then the inside dimension of the elongated outer tubes, when inserted into the elongated outer tubes they produce a telescoping tube;
c. a pair of essentially horizontal inner tubes, each one of the pair of essentially horizontal inner tubes is welded to one of the pair of essentially upright elongated inner tubes to form a essentially right angle assembly;
d. a tool tray, that includes a tunnel to receive the two essentially horizontal inner tubes, said tool tray essentially allows the essentially horizontal inner tubes to telescope within the said tunnel, said tunnel may be open ended or be divided with a wall within, said tool tray includes various pass through openings for holding tools and the like, said tool tray includes a protruding member to accept a wire handle, said tool tray includes a container body having a plurality of side walls and bottom joined together;
e. each upright elongated telescoping tube includes an indexing pin to stop the essentially upright elongated inner tube in position;
f. both upright elongated telescoping tubes include a matching plurality of indexing hole positions for the said indexing pins to stop in;

12. A step ladder safety device and tool tray as in claim 11 wherein said telescopic tubes may be any shape of tubing including square, round, rectangular, oval, triangular or oblique.

13. A step ladder safety device and tool tray as in claim 11 is secured to the step ladder with structurally approved fasteners, adhesives and clamps.

14. A step ladder safety device and tool tray as in claim 11 may be made from any combination of metals, composites or plastics.

15. A step ladder safety device and tool tray as in claim 11 wherein said telescopic tubes are stopped using telescoping tube clamps.

16. A safety device used on a step ladder comprising front side rails and horizontal locking spreaders bars, the safety device comprising:
a. a pair of essentially upright elongated outer tubes, each with a single fixed upper mounting bracket and a single unfixed lower mounting bracket, said essentially upright elongated outer tubes are mounted on the front side rails, said upper brackets have an essentially perpendicular front lap hook that hooks over a front edge of the front side rails, these said upper brackets are fixed to the essentially upright elongated outer tubes, said lower brackets have an essentially perpendicular back lap hook that hooks over a back edge of the front side rails, these said lower brackets are mounted after finding a location along the length of said outer tubes that is below the said upper bracket and does not interfere with the horizontal locking spreader bars of the step ladder, said upper and lower brackets raise the said essentially upright elongated outer tubes from the step ladder front side rails to allow for the horizontal locking spreader bars of the step ladder to clear under the said essentially upright elongated outer tubes, said upper and lower brackets are secured to the step ladder using high strength double sided mounting tape;
b. a pair of essentially upright elongated inner tubes, said elongated tubes have a smaller outside dimension then the inside dimension of the elongated outer tubes, when inserted into the elongated outer tubes they produce a telescoping tube;
c. a pair of essentially horizontal inner tubes, each one of the pair of essentially horizontal inner tubes is welded to one of the pair of essentially upright elongated inner tubes to form a essentially right angle assembly;
d. an essentially horizontal outer tube to receive the essentially horizontal inner tubes;
e. each upright elongated telescoping tube includes an indexing pin to stop the essentially upright elongated inner tube in position;
f. both upright elongated telescoping tubes include a matching plurality of indexing hole positions for the said indexing pins to stop in;

17. A step ladder safety device as in claim 16 wherein said telescopic tubes may be any shape of tubing including square, round, rectangular, oval, triangular or oblique.

18. A step ladder safety device as in claim 16 is secured to the step ladder with structurally approved fasteners, adhesives and clamps.

19. A step ladder safety device as in claim 16 may be made from any combination of metals, composites or plastics.

20. A step ladder safety device as in claim 16 wherein said telescopic tubes are stopped using telescoping tube clamps.
